(19) United States
(12) Patent Application Publication
(10) Pub. No.: US 2023/0033737 A1
(43) Pub. Date: Feb. 2, 2023

(54) METHOD AND SYSTEM OF COMPLIANCE SCENARIO PREDICTION

(71) Applicant: INTUIT INC., Mountain View, CA (US)

(72) Inventors: Carol Ann HOWE, San Diego, CA (US); Saikat MUKHERJEE, Mountain View, CA (US); Anu SREEPATHY, Mountain View, CA (US); Cem UNSAL, Mountain View, CA (US); Shashi ROSHAN, Mountain View, CA (US)

(73) Assignee: INTUIT INC., Mountain View, CA (US)

(21) Appl. No.: 17/390,612

(22) Filed: Jul. 30, 2021

(51) Int. Cl. G06N 5/02; G06K 9/62

(52) U.S. Cl. CPC G06N 5/025; G06N 5/022; G06K 9/6259

(57) ABSTRACT

A computer-implemented system and method for predicting rule-based compliance scenarios to implement rule-based topic determinations. A server computing device generates a compliance scenario prediction model by training a machine learning model for a topic with historical user data and cohort labels created by analyzing the scenarios in a completeness graph to predict a set of scenario cohorts that constitute a set of most probable compliance scenarios. The server computing device executes the scenario prediction model to process a user profile including data features associated with the topic to predict a scenario cohort and a compliance scenario corresponding to the predicted cohort for the user. The server computing device automatically infers one or more personalized responses to at least one question of the respective decision node based on the predicted compliance scenario.

### BACKGROUND

In a complex compliance rule-based technical domain (e.g., digital form filing software applications and services), there are several possible scenarios that require users to answer a series of several questions before a software service identifies the correct scenario that applies to the user. Tasks to fulfil requirements for a topic or implement a particular topic determination may represent particular scenarios encoded as compliance rules. During the digital form filing processes, these compliance rules may be translated to questions that a user needs to answer in an interview-based workflow where the next question for a user depends on the answer given to the previous question.

The existing topic qualification or scenario determination processes use completeness data structures or graphs to determine whether a user qualifies for a topic or not. For example, the Intuit® knowledge engine platform simplifies form filing processes using completeness graphs by asking questions in an interview-based flow, where the next question asked depends on the answer given to the previous question. A completeness graph for a topic is also used to determine whether user data required to determine a specific scenario in the topic was obtained. For example, the completeness graph for the topic may be executed by a processor to process user data and generate a series of dependent questions based on the predefined logical dependency of compliance rules for a topic in a user interview flow. The execution of the compliance rules is dependent on user inputs and calculated values of certain data fields along completion paths within the completeness graph. Manually providing this much input to answer questions in the interview flow results in a time-consuming process during online rule-based topic qualification determinations. Such an inefficiency becomes more pronounced in an online live system where the system requires an expert to solicit information from a user to implement related topic determinations.

### BRIEF DESCRIPTION OF THE FIGURES

The foregoing and other aspects of embodiments are described in further detail with reference to the accompanying drawings, in which the same elements in different figures are referred to by common reference numerals. The embodiments are illustrated by way of example and should not be construed to limit the present disclosure.

FIG. 1 illustrates an example computing system according to some embodiments of the present disclosure.

FIG. 2A schematically illustrates an example of a partial completeness graph that may be used in some embodiments of the present disclosure.

FIG. 2B illustrates an example decision table based on or derived from the completeness graph of FIG. 2A that may be used in some embodiments of the present disclosure.

FIG. 3 illustrates example completeness paths corresponding to compliance scenarios related to an example completeness graph in accordance with some embodiments disclosed herein.

FIG. 4 illustrates a conceptual diagram of generating a compliance scenario prediction model in accordance with some embodiments of the present disclosure.

FIG. 5 is a flowchart illustrating an example process for generating the compliance scenario prediction model in accordance with some embodiments disclosed herein.

FIG. 6A illustrates example diagrams of scenario cohorts in accordance with some embodiments disclosed herein.

FIG. 6B illustrates a simplified version of an original completeness graph and in accordance with some embodiments disclosed herein.

FIG. 7 is a flowchart illustrating an example process for applying the generated scenario prediction model to process new user profiles for predicting compliance scenarios and scenario cohorts for users during a runtime prediction in accordance with some embodiments disclosed herein.

FIG. 8A illustrates an example compliance scenario related to a compliance scenario prediction model in accordance with some embodiments disclosed herein.

FIG. 8B illustrates an example decision node representing a function related to compliance scenarios in FIG. 8A in accordance with some embodiments disclosed herein.

FIG. 8C illustrates an example table quantifying the benefit of question reduction with respect to a list of generated scenario cohorts in accordance with some embodiments disclosed herein.

FIG. 9 is a flowchart illustrating an example process of executing a compliance scenario prediction model for runtime prediction in accordance with some embodiments disclosed herein.

FIG. 10 shows an example diagram illustrating differences between the original multiple interview screens and a single dynamic interview screen with personalized responses to decision questions in accordance with some embodiments disclosed herein.

FIG. 11 is a block diagram of an example computing device according to some embodiments of the present disclosure.

### DETAILED DESCRIPTION

Embodiments of the present disclosure provide predicting techniques suitable for interview-based workflows by combining machine learning algorithms with rule-based completeness data structures to predict user cohorts and rule-based compliance scenarios for optimizing compliance rules to efficiently implement related topic determinations.

The disclosed principles provide a practical solution to problems described above with a machine learning based scenario prediction system. In one or more embodiments, the scenario prediction system includes a compliance scenario prediction model that is generated by training a machine learning model with user features and completeness paths based on predefined compliance rules and logical dependency relationships built in a completeness graph. The compliance scenario prediction model is executed by a processor or a computing device to receive and process a user profile in real time to predict a scenario cohort for the user and map the predicted cohort to the set of the compliance scenarios in the related completeness graph to predict a compliance scenario. The compliance scenario prediction model is further executed to automatically infer personalized responses to the most relevant decision questions of the decision nodes of the compliance scenario and generate the most relevant questions associated with the completeness graph for a user, thereby reducing the number of questions presented to the user and eliminating the need for user input for all questions associated with the compliance scenario.

Embodiments of the present disclosure provide improvements on how to accurately predict a scenario cohort and corresponding compliance scenario for the user and automatically infer personalized responses to decision questions associated with the compliance scenario. Embodiments of the present disclosure create a simplified and personalized user experience, make a rule-based topic determination more quickly, accurately, and effectively, and significantly reduce the time required for an overall rule-based topic implementation.

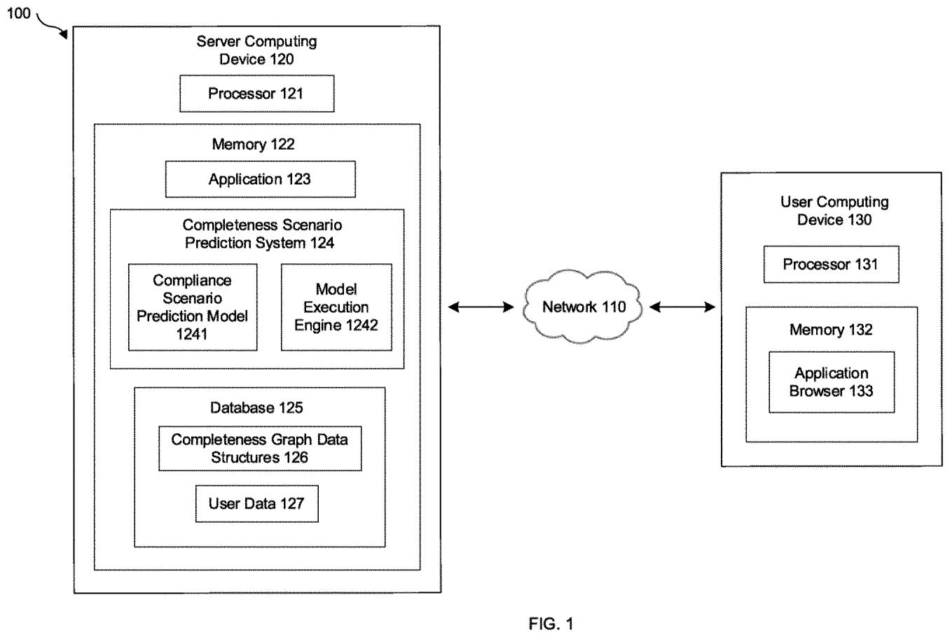

FIG. 1 illustrates an example computing system 100 for automatically predicting the correct scenario cohorts that a user may belong to in order to infer personalized responses in a completeness graph data structure in accordance with the disclosed principles. The example computing system 100 includes a server computing device 120 and at least one user computing device 130 that may be communicatively connected to one another in a cloud-based or hosted environment by a network 110. Server computing device 120 may include a processor 121, memory 122 and a communication interface (not shown) for enabling communication over the network 110. The network 110 may include the Internet and/or other public or private networks or combinations thereof.

The server computing device 120 may host one or more software services or products in the cloud-based or hosted environment. The one or more online software services may be indicative of one or more applications 123 stored in memory 122. The one or more applications 123 are executed by the processor 121 for providing one or more websites with corresponding services for interacting with users. For example, the applications 123 may provide functionalities to complete online rule-based topics associated with the software services. The rule-based software services may include, but are not limited to, online digital form filling applications such as tax returns, mortgage applications, insurance applications, college applications, and/or financial aid applications, to name a few. The corresponding rule-based topics may operate on particular rules associated with a plurality of topics to determine whether user data satisfies the requirements in topics for completing the topic-based topic determination.

The one or more applications 123 may continuously receive and update user data 127 or user data features captured from software services or other data resources associated with user accounts and the software services via the network 110.

Memory 122 stores a topic-based completeness scenario prediction system 124, including various operatable program modules or models, which are implemented by computer-executable instructions executed by the processor 121 for implementing methods, processes, systems and embodiments described in the present disclosure. Generally, computer-executable instructions include software programs, objects, models, components, data structures, and the like that perform functions or implement particular data types. The computer-executable instructions may be stored in a memory communicatively coupled to a processor and executed on the processor to perform one or more methods described herein. In some embodiments, the completeness scenario prediction system 124 includes a trained compliance scenario prediction model 1241 and a model execution engine 1242. The model execution engine 1242 includes computer-executable instructions executed by the processor 121 to generate predicted cohorts and compliance scenarios and to implement the processes, systems and embodiments described in the present disclosure.

Database 125 may be a data store included in the server computing device 120 or coupled to or in communication with the processor 121 of the server computing device 120 via the network 110. Database 125 may include completeness graph data structures 126 and historical user data 127 (e.g., user feature datasets) as disclosed herein. Database 125 may store user account information associated with user data 127 corresponding to respective digital profiles and forms. The user data 127 is represented by feature datasets that include any type of comprehensive data features such as contextual and/or numerical data, such as numbers, natural language words, terms, phrases, sentences, or any combination thereof. The user data 127 may be collected from other digital resources associated with software services and user accounts. For example, an online service built on completeness graph data structures 126 may be executed to process user data or a user profile to present a list of related questions or data fields on a series of interview screens on a display of a user computing device 130. The user may enter the appropriate responses or answers. The processor 121 captures user inputs or user data features associated with a plurality of user accounts to make a completeness determination and determine whether the user data satisfies all requirements for the topic determination of the completeness graph data structure. In one embodiment, the online application service may be a financial management service such as Mint®, a tax preparation application such as TurboTax®, or an online application such as QuickBooks Online®, each of which are provided by Intuit Inc. of Mountain View, Calif. For example, a user may sign onto an online software service product via a user computing device 130 to perform form filing activities (e.g., tax returns). The online application service may include over one hundred different topics. Each topic includes rules and functions to capture all required variables from user data necessary to complete determination and calculations that are required to complete a topic qualification determination.

The user data profile, user inputs, and topic/scenario determination results may be stored in the database 125 as historical user data 127. The historical user data 127 may include tens, hundreds or thousands of data features associated with a plurality of users related to a topic. For example, the historical user data may include user information data, data from certain topics such as income data obtained from tax return forms (e.g., W-2, 1099, etc.) in a tax domain. The historical user data may be used to identify scenario cohorts corresponding to completeness paths and compliance scenarios in completeness graphs and train machine learning models to generate compliance scenario prediction models for different topics to build a completeness scenario prediction system 124.

A user computing device 130 includes a processor 131, a memory 132, and an application browser 133. For example, a user computing device 130 may be a smartphone, personal computer, tablet, laptop computer, mobile device, or other device. Users may be registered customers of the one or more applications 123. Each user may create a user account with user information for subscribing and accessing a particular online rule-based filing tasks related to software service or product provided by the server computing device 120.

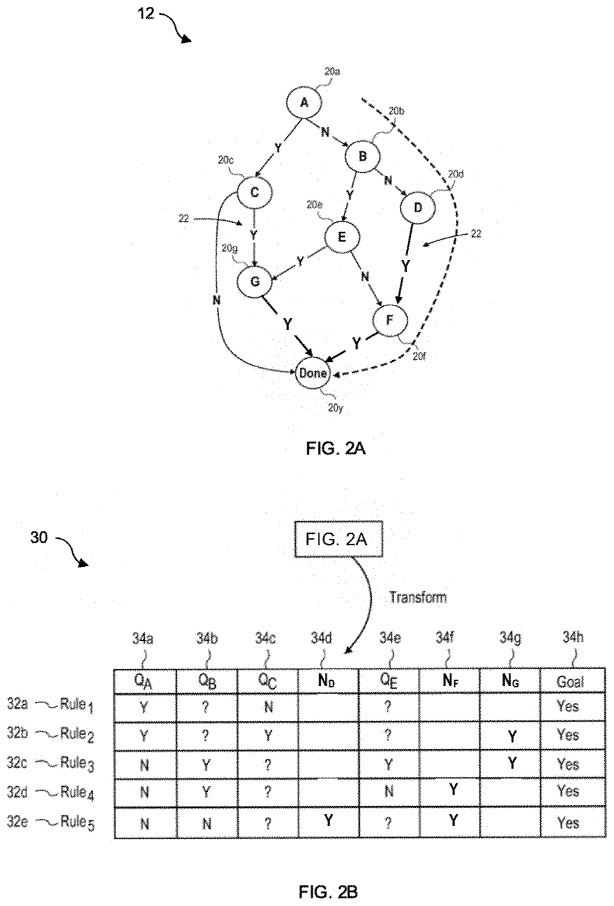

FIG. 2A schematically illustrates an example of a partial completeness graph data structure 126 that may be used in some embodiments of the present disclosure. For example, a completeness data structure 126 associated with a topic may be illustrated as a completeness graph 12 that may be constructed in the form of a decision tree. The illustrated completeness graph 12 includes a plurality of interconnected and logically dependent functional nodes 20 and edges 22 to form completeness paths for making a topic completion determination. The edges 22 represent response options or logical relationships between the nodes. The nodes and edges represent respective rules and regulations associated with questions for a topic determination. For example, the rules and logical relationships between the nodes and edges related to a topic may be used to determine whether user moving expenses qualify for reimbursements, whether a child qualifies as a dependent for federal income tax purposes, etc. A completeness graph may include non-decision functional nodes and decision functional nodes. A non-decision functional node (e.g., non-decision node) may be a data entry node configured to be executed by a process to receive user input through a user interface, such as “The number of miles travelled.” A non-decision functional node may be a task required to proceed to the next node. A decision functional node (e.g., decision node) represents a question or a logical condition with variables for determining conditions of a function such as “Is miles travelled >50”. The decision node may be connected to other nodes through edges based on an answer of the logical condition. Each unique combination of nodes from a beginning node to a determination node in the completeness graph represents a completeness path or completeness scenario.

As illustrated in FIG. 2A, the completeness graph 12 includes a beginning node 20a (Node A), intermediate nodes 20b-g (Nodes B-G) and a termination node 20y (e.g., determination Node “Done”). The completeness graph 12 includes decision nodes A, B, C, and E and non-decision nodes D, F, and G. Each decision node represents a question or a logical condition with variables for determining conditions of a function. Each decision node has more than one edge 22 and contains a condition representing a question with decision values that may be expressed as a Boolean expression that may be answered in the affirmative or negative. Each inter-node connection or edge 22 from a decision node represents an answer or response option with a decision value in the binary form of “yes/no” (Y/N), or with a response to a Boolean expression (“True” or “False”). Based on user data, the decision node may result in a decision value of “yes/no” or “true/false” evaluations and hence cause edges between the nodes in the completeness graph. The decision value (Y/N) of the decision node leads to a determination of which node or path to traverse next. It will be understood, however, that embodiments are not so limited, and that a binary response form is provided as a non-limiting example. Non-decision nodes D, F, and G represent tasks to be performed along a completeness path for a topic determination. As illustrated in FIG. 2A, values from non-decision nodes D, F, and G are denoted as “Yes (Y)”. A completeness path may be determined to proceed from a non-decision node to the only possible next node in the path irrespective of the value of the non-decision node.

The edges 22 that connect each node 20 illustrate the dependencies between nodes 20. The combination of edges 22 in the completeness graph 12 illustrates the several logically dependent completeness paths to complete a topic determination based on the dependent logics between the nodes and edges according to the compliance rules of the topic. A single edge 22 or combination of edges 22 result in a determination of “Done” or “Completed” at the determination node 20y. A combination of the nodes and edges represent a path to generate a result to show whether user data satisfies the requirements for the rule-based topic determination.

As illustrated in FIG. 2A, the completion graph 12 may be traversed through all possible paths from the beginning node 20a to the termination node 20y. By navigating various paths through the completion graph 12 in a recursive manner, the system may determine each path from the beginning node 20a to the termination node 20y. The completion graph 12 along several paths to completion through the graph may be converted into a different data structure or format such as a decisions table.

FIG. 2B illustrates an example decision table based on or derived from the completeness graph of FIG. 2A. The decision table 30 includes five rows 32a-e corresponding to the completion paths related to compliance rules (e.g., Rule₁-Rule₅) through the completion graph 12. In the illustrated embodiment, the columns 34a-g represent expressions for each of the questions (represented as nodes A-G in FIG. 2A) and decision values or answers derived from completion paths through the completion graph data structure 126 and column 34h indicates a conclusion, determination, result or goal concerning a topic or situation, e.g., “Yes—qualifying a topic” or “No—not qualifying a topic.”

Referring to FIG. 2B, each row 32 of the decision table 30 represents a completeness path with a compliance rule or regulation to implement a topic determination process. Decision nodes A, B, C, and E correspond to questions Q_{A}, Q_{B}, Q_{C}, and Q_{E}, respectively. Non-decision nodes D, F, and G correspond to N_{D}, N_{F}, and N_{G}, respectively. The decision table 30, for example, may be associated with a compliance rule such as a state tax rule. The decision table 30 can be used, as explained herein, to drive a personalized interview process for the user. In particular, the decision table 30 is used to select one or more questions to present to a user on a series of interview screens during an interview process. In this particular example, in the context of the completion graph from FIG. 2A converted into the decision table 30 of FIG. 2B, if the first question presented to the user during an interview process is question “A” (Q_{A}) and the user answers “Yes”, rows 32c-e may be eliminated from consideration given that no completion path to completion is possible. The compliance rules associated with these columns cannot be satisfied given the input of “Yes” in question “A”. The cell entries denoted by “?” represent those answers to a particular question that are irrelevant to the particular path to completion. Thus, for example, referring to the path/row 32a, when an answer or decision value to Q_{A} is “Y”, a path is completed through the completion graph 12 by answering Question C as “N” and then proceeding to the question in node E. The answer to question Q_{E} in row 32a is denoted as “?” since it is not needed to be answered for that path. In another example, referring to the path/row 32c, when an answer or decision value to question Q_{A} at node A is “N” the path is completed by answering question Q_{B} as “Y” and question Q_{E} as “Y” before proceeding to non-decision node G with a value of “Y” before reaching the termination node (“Done”). Empty cells related to non-decision nodes N_{D}, N_{F}, and N_{G} indicate that the nodes are not required.

After an initial question has been presented and rows are eliminated as a result of the selection, a collection of candidate questions from the remaining available rows 32a and 32b is determined. From this universe of candidate questions from the remaining rows, a candidate question is selected. When the answer to the initial question Q_{A} is “Y”, the candidate question becomes question Q_{C} in column 34c. The question is selected and the process repeats until either the goal or topic qualification determination 34h is reached or there is an empty candidate list.

A system operating completeness graphs requires a processor to process user data by traversing the completeness graph through all possible completeness paths from the beginning node 20a to the termination node 20y, the processor needs to go through a lot of decision nodes and non-decision nodes to determine decision values of the nodes and identify whether there are unanswered questions through the completeness paths and present the questions on multiple interview screens for receiving user's answers in an interview-based workflow. The interview-based workflow depends on the calculated decision values based on the user input or user data to answer the questions at the decision nodes before the processor identifies the right completeness path that applies to the user to make a completed topic determination. Given the complexities of the compliance rules or regulations associated with a plurality of topics, a completeness data structure or completeness graph 12 may contain hundred nodes with a great number of paths for determining a topic qualification completion. As shown in Table 1, the columns of Full Graph shows the complexity of original completeness graphs for different topics. For example, an example original completeness graph for a rule-based topic related to moving expenses includes 94 nodes and 112 edges. An example original completeness graph for a rule-based topic related to stock sales includes 339 nodes and 415 edges. A “sink” refers to an end state (e.g., determination Node “Done”) in the completeness graph. A simplified version of the completeness graph may be obtained to only include decision nodes by removing the non-decision nodes in the graph, thereby reducing the number of nodes and the number of edges. The columns of simplified graphs show that many nodes and edges are eliminated for different topics. For example, an example simplified completeness graph related to moving expenses includes 35 nodes and 51 edges. The number of end states or sinks do not change in the simplified version of the completeness graph.

TABLE 1

| | Full Graph | | | Simplified Graph | | | |
|---|---|---|---|---|---|---|---|
| Topic | Nodes | Edges | Sinks | Nodes | Edges | Sinks | Paths |
| Moving | 94 | 112 | 2 | 35 | 51 | 2 | 106 |
| Expenses | | | | | | | |
| Stock Sales | 339 | 415 | 13 | 123 | 163 | 13 | 1175 |
| Retirement | 621 | 890 | 1 | 332 | 578 | 1 | Millions |

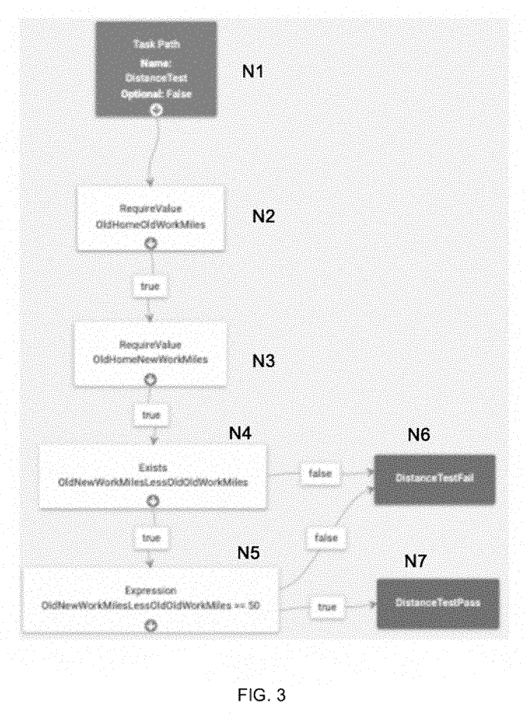

An example completeness graph may include more than 100 compliance scenarios that correspond to the related topic completeness paths to determine the topic qualification. FIG. 3 illustrates example completeness paths corresponding compliance scenarios related to an example completeness graph for moving expenses in accordance with some embodiments disclosed herein. The compliance scenarios correspond to the completeness paths and include a set of decision nodes N1-N7. The groups of users having user data to traverse the same scenario to complete the topic and constitute a scenario cohort. Each compliance scenario corresponds to a scenario cohort and a completeness path.

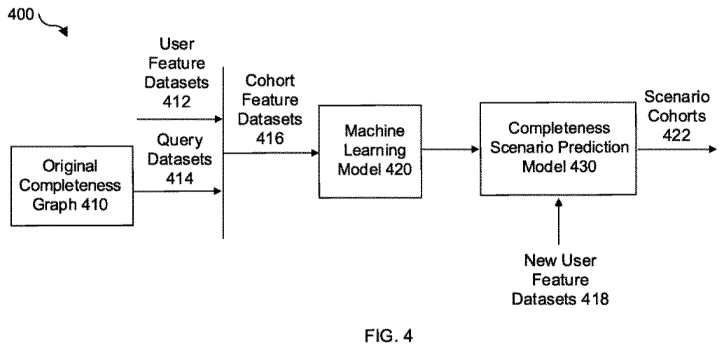

FIG. 4 illustrates a conceptual diagram 400 of generating a compliance scenario prediction model in accordance with the disclosed principles. Embodiments of the present disclosure combine a rule-based completeness graph 410 and the machine learning to generate a compliance scenario prediction model 430 to implement scenario cohort predictions with optimal rules execution and an increased service speed for determining a topic completion. Embodiments of the present disclosure provide solutions by training a machine learning model 420 with cohort feature datasets 416. The processor may detect query datasets 414 based on an original completeness graph for a topic. Query datasets 414 are applied on the known user feature datasets 412 to generate the cohort feature datasets 416 and cohort labels. The cohort feature datasets 416 represent user data features corresponding to groups of users or cohorts with cohort labels (not shown). The machine learning model 420 is trained by a processor with cohort feature datasets 416 to generate a trained machine learning model as a compliance scenario prediction model 430. The compliance scenario prediction model 430 is executed by the processor to process new user profiles or new user feature datasets 418 to predict scenario cohorts 422 for the users.

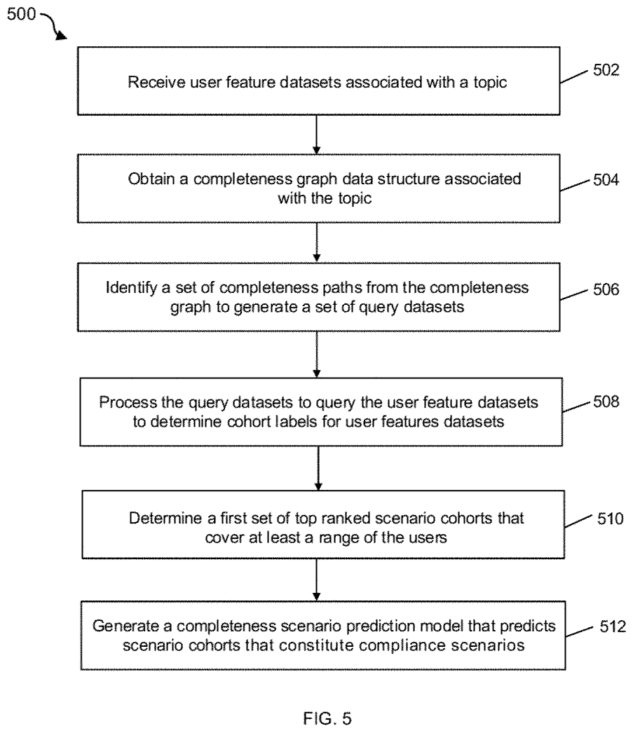

FIG. 5 is a flowchart illustrating an example process 500 for generating the compliance scenario prediction model corresponding to the conceptual diagram 400 in accordance with some embodiments disclosed herein. The process 500 may be configured to include computer programs (e.g., software) executed on one or more computers or servers including server computing device 120, in which the models, processes, and embodiments described below can be implemented.

At step 502, the processor 121 receives known user feature datasets 412 from the historical user data 127 associated with a plurality of users and a topic. The known user feature datasets may be constructed to include data features related to questions and corresponding answers or responses in completeness graphs of certain topics based on historical user data associated with user accounts stored in the database in communication with the processor. The user feature datasets may include over three hundred different data features associated with about three hundred thousand users in relation to the topic. For example, in tax filing service domain, the known user feature datasets may include features derived from user account data, personal information and digital filing forms, including but not limited to W2 forms, getting to know me (GTKM) forms, federal information worksheet (Info Wks), etc.

At step 504, the processor 121 obtains a completeness graph 410 stored in the database 125 associated with a rule-based topic. The completeness graph includes a plurality of decision nodes. The decision nodes are interconnected by edges based on dependent logics of compliance rules of the topic. Each decision node represents a question with variables required to answer the question and a question with a functional condition to determine respective decision values. The connected edges represent respective decision values indicative of conditional results based on the user data or input to answer to the question. The decision values corresponding to the decision nodes in the completeness graph may be Boolean values or logical values (“True” or “False”).

A completeness graph represents all possible compliance scenarios for a topic along with inputs that are necessary to be collected from the user for each scenario. In other words, each path in the completeness graph represents a unique scenario. The completeness graph consists primarily of two types of functional nodes to receive user inputs, such as a data entry node (e.g., non-decision node) and a decision node. The value of the decision node determines what part of the graph will be traversed next. A group of cohort users have user data that follow the same path in the completeness graph and have the same compliance scenario for the topic and hence belong to the same cohort. The user data of a cohort provides responses for the decision nodes with the same decision values. Each edge representing decision values connects two nodes from a top node to a termination node through corresponding edges along respective completeness paths. Each completeness path represents the node-edge-node logic relationships from a top node to a termination completion node.

At step 506, based on the dependent logic between the decision nodes through the edges in the completeness graph, the processor 121 identifies a set of completeness paths for completing a topic qualification determination from the completeness graph to generate a set of query datasets. The query datasets 414 include all compliance scenarios corresponding to completeness paths in the completeness graph. The compliance scenarios identify corresponding questions and answers from the beginning node to a termination node along the completeness paths. Each compliance scenario corresponds to a scenario cohort. Each query or query dataset includes a cohort label representing a compliance scenario, a set of decision nodes belonging to the compliance scenarios, respective questions and decision values for the decision nodes. In one embodiment, the processor 121 may detect the query datasets by parsing and filtering the set of decision nodes and decision values in the completeness graph based on the dependent logic between the decision nodes through the edges to generate the query datasets. Referring again to FIG. 2A, one example query (query 1) represents one path and compliance scenario corresponding to a scenario cohort (cohort 1) in the graph. Query 1 includes decision nodes A, C, and G with decision values of A=Y, C=Y, and G=Y. Another example query (query 2) represents a different path and compliance scenario corresponding to a scenario cohort (cohort 2) in the graph. Query 2 includes decision nodes A, B, D, and F with decision values of A=N, B=N, D=N, and F=N.

At step 508, the processor 121 processes the query dataset 414 to query the known user feature datasets 412 from user data 127 to determine cohort labels for the user feature datasets 412 corresponding to the respective completeness paths or compliance scenarios. The known user features datasets are used to create cohorts of users based on the set of the completeness paths that are traversed by the user feature datasets in the completeness graph. In one embodiment, traversing the completeness graph by the processor includes providing the user feature dataset for each user to data fields of variables of the questions of the decision nodes to generate a decision value. For example, the cohorts may be created from historical user data from e.g., 300,000 users who went through the topic. The user feature datasets 412 that match query 1 or query dataset 1 are labeled as scenario cohort 1. The user feature datasets 412 that match other query datasets are labeled as respective scenario cohorts corresponding to different completeness paths or compliance scenarios in the completeness graph.

At step 510, the processor 121 determines a first set of top-ranked scenario cohorts that cover at least a range of the users.

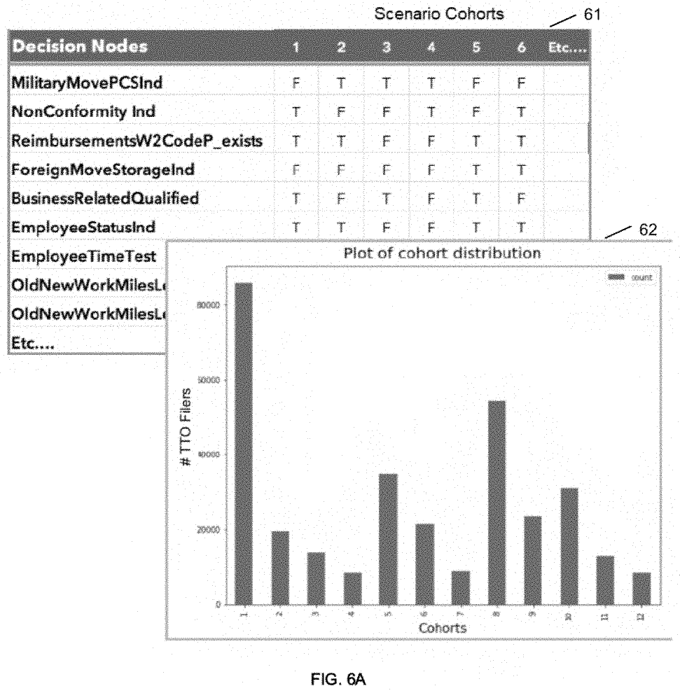

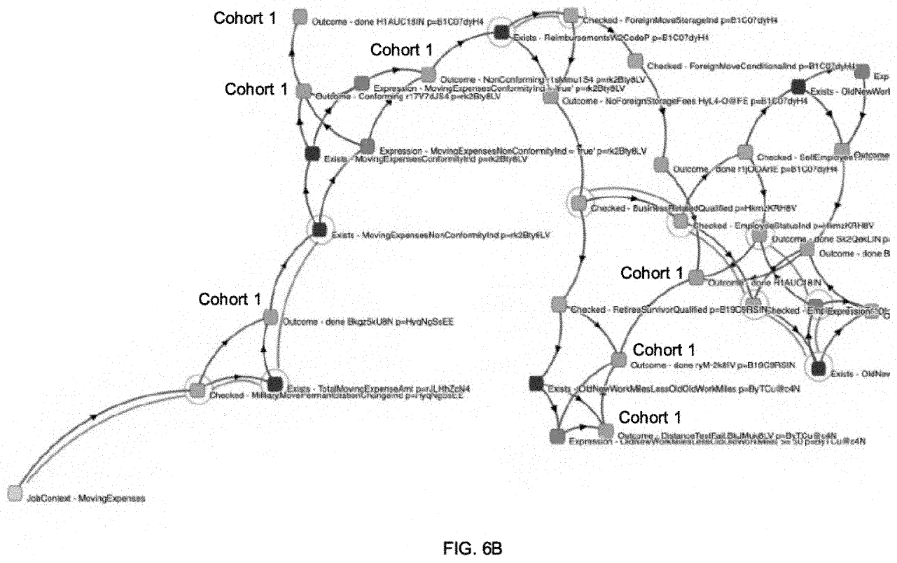

FIG. 6A illustrates example diagrams 61, 62 of scenario cohorts of an example completeness graph in accordance with some embodiments disclosed herein. The first diagram 61 shows a set of scenario cohorts for a plurality of users. Each scenario cohort has a scenario cohort label (e.g., digital value 1, 2 . . . ) corresponding to a set of decision values in a logic format of “True (T)” or “False (F)” for a list of decision nodes in a completeness graph. Based on the predetermined completeness path associated with the decision nodes and the corresponding decision values, the processor may identify and determine a completeness path to constitute a compliance scenario for a scenario cohort.

The second diagram 62 in FIG. 6A shows an example cohort distribution plot corresponding to twelve top-ranked scenario cohorts. The cohort distribution is a retrospective analysis of a population of users who went through the topic across different cohorts and scenarios. The processor may calculate and determine the cohort distribution based on a total number of users (e.g., digital form filers) for each cohort. Before training the machine learning model, the processor may select a first set of top-ranked cohorts that cover a range of 90th percentile to 95th percentile of all users associated with the stored historical user data 127. The remaining users may be put into a single cohort. For example, based on the cohort distribution, the processor selects a first set of top-ranked twelve cohorts that covers over 92% of all users. The user feature datasets associated with the first set of top-ranked scenario cohorts and cohort labels are used to train the machine learning model.

FIG. 6B illustrates a simplified version of an original completeness graph. It retains only the decision nodes from an original completeness graph for a topic related to moving expenses. In the illustrated example, some decision nodes are associated with scenario cohort 1 and a corresponding compliance scenario.

At step 512, the processor 121 generates a compliance scenario prediction model that predicts a set of scenario cohorts that constitute a set of compliance scenarios. The compliance scenario prediction model is generated by training a machine learning model or algorithm with user feature datasets 412 associated with the first set of the top-ranked scenario cohorts and the respective cohort labels as inputs to predict scenario cohorts for users. In some embodiments, the number of the top-ranked scenario cohorts may be dynamically adjusted to maximize the model cohort prediction accuracy and for future updating when retraining the models. The compliance scenario prediction model may process new user profiles to predict a set of scenario cohorts 418 corresponding to a set of compliance scenarios for the users related to the new user profile. Each compliance scenario represents a completeness path for the respective scenario cohort. Each compliance scenario includes a set of decision nodes with respective questions and decision values.

Different machine learning models or algorithms may be selected and trained to generate a compliance scenario prediction model. In some embodiments, the machine learning algorithm may use an extreme gradient boosting (XGBoost) model for performing a multi-class classification on the user feature datasets to predict scenario cohorts. An online filling service may include a plurality of completeness graphs for completing qualification determinations for different topics. The process 500 may be utilized to train machine learning models to generate a plurality of compliance scenario prediction models each associated with a particular completeness graph for implementing a rule-based topic determination. The corresponding compliance scenario prediction model may generate different numbers of scenario cohorts. The number of scenario cohorts is proportional to the complexity of the topic.

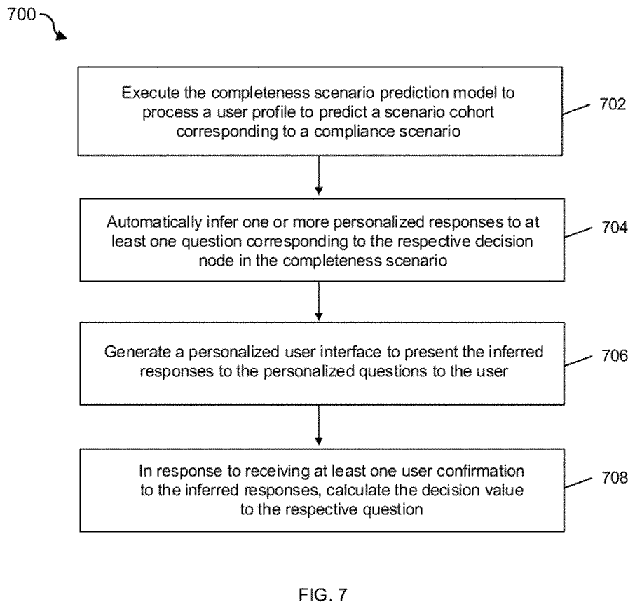

FIG. 7 is a flowchart illustrating an example process 700 for applying the generated compliance scenario prediction model to process new user profiles for predicting compliance scenarios and scenario cohorts for users during a runtime prediction in accordance with some embodiments disclosed herein. The process 700 may be configured to include computer programs (e.g., software) executed on one or more computers or servers including server computing device 120, in which the models, processes, and embodiments described below can be implemented.

At step 702, the processor 121 executes the compliance scenario prediction model to process a new user profile including new user data features associated with the topic and a user. The processor 121 may predict a scenario cohort corresponding to a compliance scenario for the user. For example, the predicted scenario cohort is one of the first set of the top-ranked scenario cohorts associated with the known user data features. The processor 121 may map the predicted scenario cohort to the corresponding compliance scenario for the user to identify the decision value or response to the respective decision node in the compliance scenario.

At step 704, based on the predicted compliance scenario that the predicted cohort maps to, the processor 121 automatically infers one or more personalized responses to at least one decision question corresponding to the respective decision node based on the predicted compliance scenario and the user feature datasets. For example, if the processor 121 predicts that the user belongs to scenario cohort 1 having a set of known decision values for the decision nodes, such as A=Y, C=Y, and G=Y, the processor 121 may infer the personalized responses to the questions related to the corresponding decision nodes A, C, and G based on the respective decision values.

At step 706, the processor 121 generates a personalized user interface to present the inferred and personalized responses to the respective decision questions to a user computing device operated by the user.

At step 708, in response to receiving at least one user confirmation to the inferred responses through the user interface from the user computing device, the processor 121 calculates the decision value to the respective decision question, presenting relevant non-decision questions and determines whether the user profile satisfies the requirements in the completeness graph for a topic determination.

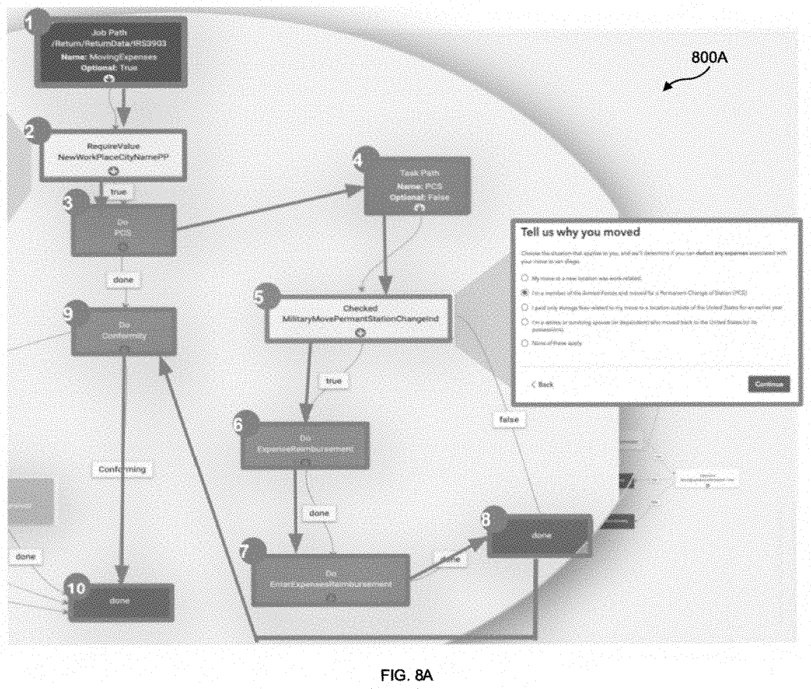

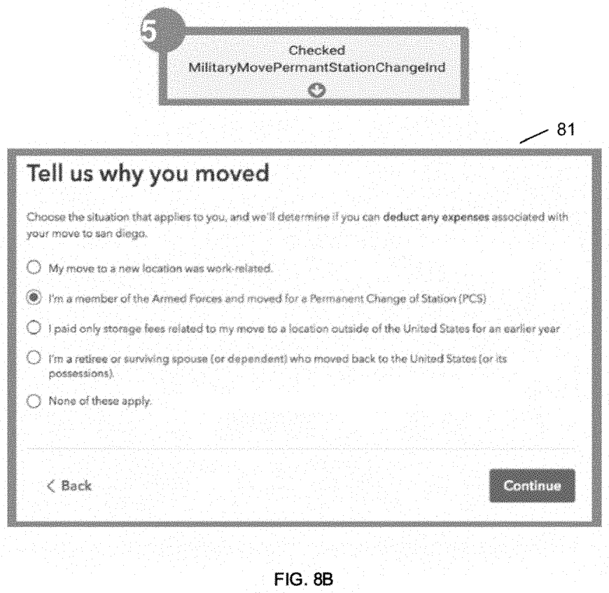

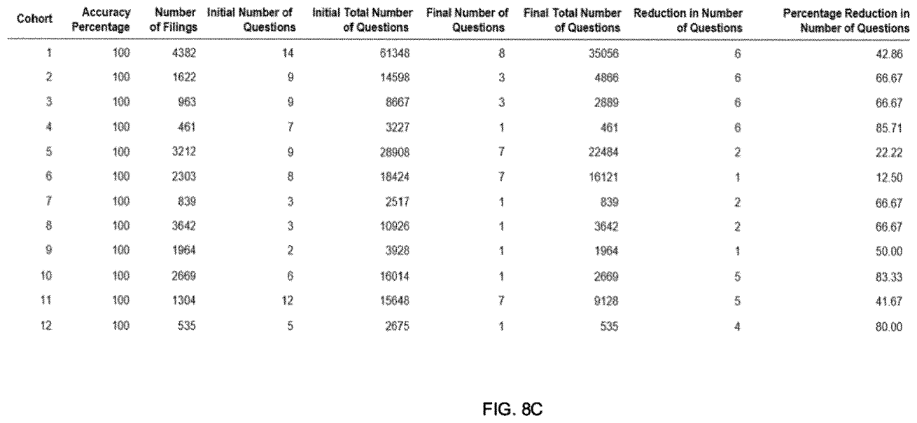

FIG. 8A illustrates an example compliance scenario 800A related to a compliance scenario prediction model based on a topic of relocation in accordance with some embodiments disclosed herein. Each compliance scenario corresponds to a list of functional nodes associated with a completeness path from the top node 1 to a termination node 10 (e.g., “Done”). In the illustrated example, the compliance scenario may include nodes 1, 2, 3, 4, 5, and 8. Another example compliance scenario may include nodes 1, 2, 3, 4, 5, 6, 7, and 8. Node 5 is a decision node representing a key question used to determine a compliance scenario. Other nodes in FIG. 8A are non-decision nodes each represent a “task” required to proceed to the next node. For example, non-decision node 2 represents a data entry node requiring user input such as “Tell me about your move.” The processor 121 may execute a model execution engine 1242 to generate and present an interview screen related to the non-decision node 2 for receiving the user input. The processor 121 may execute a model execution engine 1242 to receive the user input and directly proceed to the next node (non-decision node 3) irrespective of values of the user input at non-decision node 2. After the task associated with non-decision node 3 is completed, the compliance scenario will automatically proceed to non-decision node 9 and generate a “conforming” result to a termination node 10 (e.g., “Done,” a topic qualification completion”). Otherwise, the path may proceed from non-decision node 3 to non-decision node 4 then to decision node 5. The decision node 5 is defined to provide one or more responses to collect confirmation information from the user through a personalized user interface with corresponding selectable user interface elements. The processor 121 may execute a scenario prediction model 430 to determine which node may be executed after executing the functions at a decision node such as node 5 based on the user selections of the selectable user interface elements. With a decision value of “False” or “No” at node 5, the processor may execute the model execution engine 1242 to proceed to a Done node 8 along the completeness path. With a decision value of “True” or “Yes” at node 5, the processor may execute the model execution engine 1242 to proceed to non-decision nodes 6 and 7, and the Done node 8 along the completeness path. The processor may execute a model execution engine 1242 to continue to proceed to non-decision node 9 for a corresponding task and then to a Done node 10 along the completeness path to constitute the compliance scenario.

FIG. 8B shows an example decision node 5 representing a function related to compliance scenarios illustrated in FIG. 8A. In one embodiment, the compliance scenario prediction model is executed by the processor to infer one or more personalized responses to a question corresponding to the decision node 5. The processor may generate a personalized user interface 81 to present the inferred responses to the respective question to the user. Referring to FIG. 8B, for example, in response to receiving at least one user affirmation of the inferred responses through the personalized user interface 81 via a user computing device, the processor 121 may determine that a decision value to the question at node 5 is “True” and perform the corresponding calculations through non-decision nodes 6 and 7 to determine whether the user profile satisfies the requirements in the completeness graph for the topic determination. In another example, in response to receiving at least one user confirmation to the inferred responses, the processor 121 may determine that a decision value to the question at node 5 is “False” and proceed to a termination node 8 (e.g., “Done,”).

FIG. 8C illustrates an example table quantifying the benefit of question reduction with respect to a list of generated scenario cohorts in accordance with some embodiments disclosed herein. The processes 500 and 700 may be utilized to generate and apply the compliance scenario prediction model to process a plurality of new user profiles for predicting the listed 12 scenario cohorts. There are potential reductions in number of interview questions for the scenario cohorts if the prediction accuracy of the model is determined to be 100 percent. For example, scenario cohort 1 corresponds to a completeness path including 14 questions in which 6 are decision questions. With the compliance scenario prediction model, scenario cohort 1 may be predicted to correspond to a compliance scenario that includes inferred and personalized responses for 6 decision questions associated with the corresponding decision nodes and only requires 8 data entry questions to be answered by the user. The reduction in number of questions for predicted scenario cohort 1 is 6 and a percentage reduction in number of questions is 42.86%. If the compliance scenario prediction model accurately predicts 12 tax scenario cohorts, up to 46% of questions may be reduced by inferring responses. Not all generated scenario cohorts are equally important. For example, cohort 1 has more than 4000 users while cohort 12 has about 500 users. The overall weighted reduction in number of questions for the example topic may be determined by combing the value of “Percentage reduction in number of questions” by the value of “Number of filings”.

The trained compliance scenario prediction model may generate an outcome for a cohort prediction distribution based on the known user data 127. The accuracy measure for each generated scenario cohort may be determined based on the cohort prediction distribution during the model training process. For example, the results of the cohort prediction distribution indicate that the trained model may predict a scenario cohort with 67% accuracy. The trained compliance scenario prediction model may be executed to predict scenario cohorts for new users based on accuracy measures for the scenario cohorts determined during the model training process.

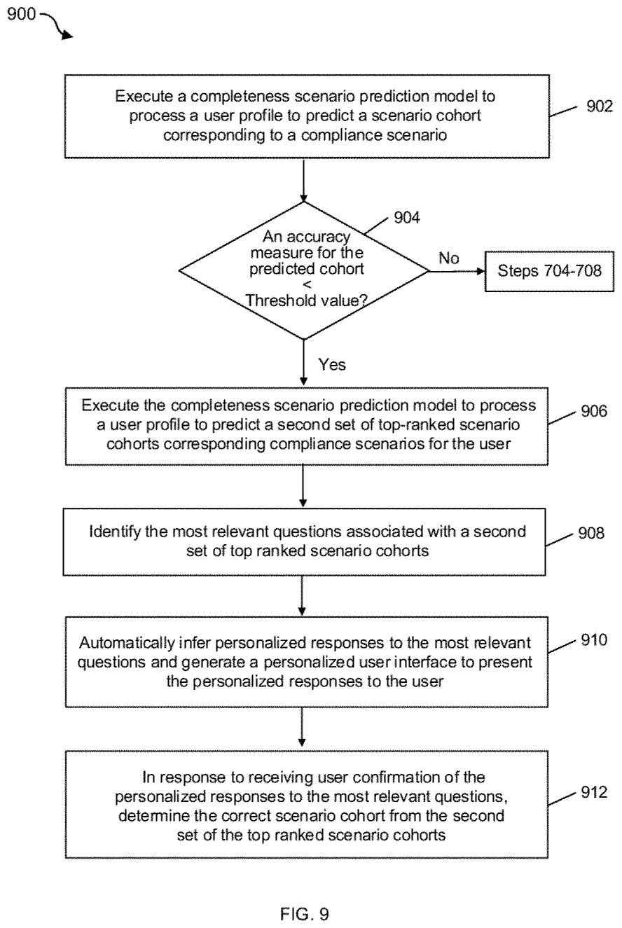

FIG. 9 is a flowchart illustrating an example process 900 of executing a compliance scenario prediction model for runtime prediction in accordance with some embodiments disclosed herein.

At step 902, the processor executes a compliance scenario prediction model to process a new user profile to predict a scenario cohort corresponding to a compliance scenario in a completeness graph for a topic. The processor receives a user profile including data features associated with the topic and a user from a user computing device 130. The new user profile includes user data features associated with certain topics including the current topic related to the compliance scenario prediction model. The new user profile is received and available before the processor executes the completeness graph of the current topic. The processor may predict a most probable scenario cohort corresponding to a compliance scenario for the user.

At step 904, the processor determines whether an accuracy measure of predicting the most probable cohort for the user is lower than a threshold value (e.g., 90%). For example, based on accuracy measures from a prediction probability distribution of a first set of scenario cohorts determined during training the compliance scenario prediction model, there may be a 67% test accuracy for predicting the most likely cohort.

At step 906, in response to determining that the accuracy measure of the predicted cohort for the user is lower than the threshold value, the processor may execute the compliance scenario prediction model to predict a second set of top-ranked and most probable scenario cohorts based on the predetermined accuracy measures of the first set of the predicted scenario cohorts from the prediction probability distribution. In response to determining that the accuracy measure of the predicted cohort for the user is not lower than a threshold value (a no at step 904), the processor executes the steps 704-708 in the process 700.

In some embodiments, the second set of top-ranked scenario cohorts are predicted based on the first set of the scenario cohorts. The number of the second set of the top-ranked scenario cohorts may be dynamically adjusted to maximize a total accuracy measure of the second set of the predicted cohorts to be above the threshold. In some embodiments, the compliance scenario prediction model processes a new user profile including data features associated with the topic and predicts at least the three top-ranked scenario cohorts including the correct scenario cohort for a user. These top-ranked three predicted scenario cohorts are the most probable cohorts resulting in 91% accuracy measure based on the cohort prediction distribution. Each scenario cohort corresponds to a compliance scenario in the completeness graph. Each compliance scenario includes a collection of decision nodes. Each decision node corresponds to a decision question being asked to the user.

At step 908, the processor automatically identifies the most relevant personalized questions of the decision nodes in the compliance scenarios associated with the second set of the top-ranked scenario cohorts. In one embodiment, the most relevant personalized decision questions are related to decision nodes in at least three top-ranked scenario cohorts and corresponding compliance scenarios. Based on these three top-ranked predicted scenario cohorts, the processor identifies the decision nodes in the corresponding compliance scenarios. The processor obtains the decision questions corresponding to the identified decision nodes of the three compliance scenarios. These decision questions constitute the most relevant decision questions of the decision nodes in the predicted scenario cohorts and compliance scenarios for the topic determination. At step 910, the processor automatically infers personalized responses to the most relevant decision questions and generates a personalized user interface to present the personalized responses to the decision questions to the user.

At step 912, in response to receiving user confirmation of the personalized responses to the personalized decision questions of the decision nodes, the processor determines the correct and most probable scenario cohort from the second set of the top-ranked cohorts for the user. The correct and most probable scenario cohort is mapped to a compliance scenario that corresponds to a set of decision nodes, corresponding decision questions, and decision values along the respective completeness path. Based on the user confirmation of the personalized responses to some decision questions of the related decision nodes in a compliance scenario, other decision questions and corresponding decision nodes may be precluded. The processor may automatically and quickly identify the correct scenario cohort and the corresponding compliance scenario for the user to implement a topic determination.

In some embodiments, for the second set of n top-ranked scenario cohorts, the processor identifies the decision nodes that have conflicting predicted responses. In order to disambiguate and predict the most probable scenario cohort among the n top-ranked scenario cohorts, the processor dynamically reorders the most relevant personalized questions to ask the disambiguating questions upfront thereby modifying a sequence of the questions corresponding to the decision nodes and non-decision nodes along the completeness path while minimizing the total number of questions presented to the user.

The process 900 provides an optimized solution by combining a completeness graph and machine learning to automatically predict the most probable scenario cohorts and the corresponding compliance scenarios based on new user profiles for new users.

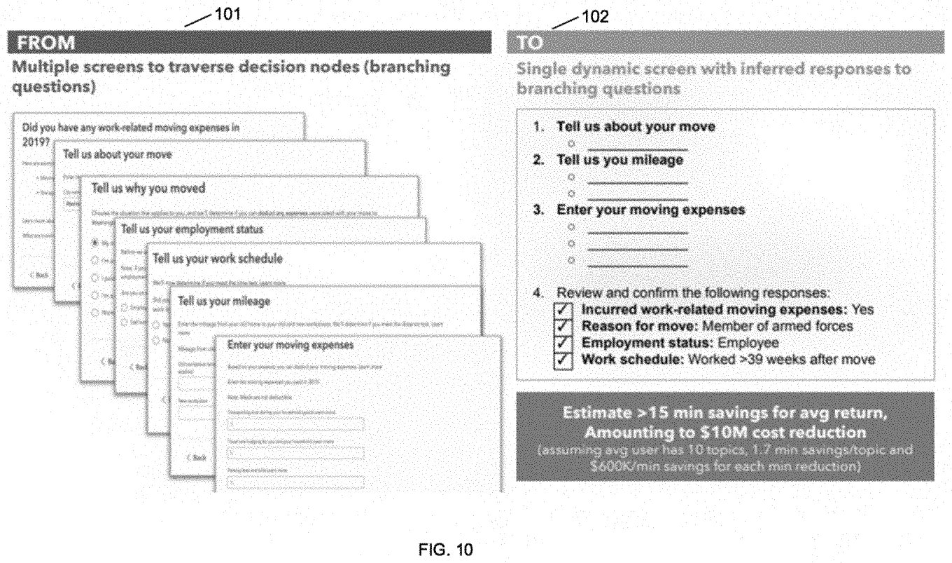

FIG. 10 shows an example diagram illustrating differences between the original multiple interview screens 101 and a single dynamic interview screen 102 with personalized responses to decision questions in accordance with some embodiments disclosed herein. In a system where no prediction models are used, multiple interview screens 101 are generated by traversing nodes in a completeness graph with user data and each screen includes one or more questions. The original multiple interview screens 101 require user input for all questions along one or more paths in the completeness graph. With the compliance scenario prediction model, the processor processes a user profile to identify the most relevant decision questions at decision nodes of the completeness graph. The processor infers personalized responses to the most relevant decision questions and further generates and presents an example personalized user interface. The personalized user interface includes a single dynamic interview screen 102 with inferred responses to the most relevant decision questions including data entry questions 1, 2, and 3. As illustrated in FIG. 10, the single dynamic interview screen 102 includes inferred responses (e.g., item 4) to the most relevant questions for the user to confirm. The single dynamic interview screen 102 includes some other relevant data entry questions (e.g., items 1, 2, and 3) which may be personalized and generated based on user data features.

In some embodiments, completeness graphs may be simplified by eliminating a set of questions and edges that do not belong to the predicted compliance scenario and are not related to the predicted scenario cohorts.

In some embodiments, when the completeness graph is complex, the system may include hierarchical clusters/cohorts. Multiple machine learning models may be trained for the different layers of clusters/cohorts. For example, a higher level prediction model may be executed to predict 3 top-ranked cohorts. Each of these cohorts may include a set of sub-cohorts that belong to a subtopic. Finer level models may be applied to predict the correct sub-cohort. This approach simplifies the computations and increases prediction accuracy. Meanwhile, the total of questions to be answered are significantly reduced by avoiding asking the user every question in the predicted scenario corresponding to the completion path.

Embodiments of the present disclosure provide a new approach to combine completeness graph data structures and machine learning models or algorithms to generate compliance scenario prediction models by optimizing compliance rules execution, improving efficiency and increasing service speed of determining a topic qualification completion. Different completeness scenario prediction models may be generated by training machine learning models with different completeness graphs for a plurality of topics. The completeness scenario prediction models may be validated and deployed into a practical software product system, or hosted on a server computing device 120 or a website that a user computing device 130 may access through the network 110.

The methodology of the present disclosure may be reused and applied to process user data and collect required information for completing online rule-based topic determination events in different areas. The compliance scenario prediction models may be constructed to reduce or minimize the nodes and edges to simplify completeness paths.

A software product may include a hundred of different scenario prediction models constructed for different rule-based topics and executed by a computer to implement corresponding topic determination in response to user requests. The compliance scenario prediction models may be integrated into an online product as a practical application to perform an online live full-service platform with an increase service speed to determine a topic qualification completion. This helps reduce the overall customer service time by avoiding the back and forth between the expert and the user. For example, with reference to Turbo Tax Live (TTlive), full-service customer service time (CST) associated with an example online application service includes information gathering, form filing preparation, evaluation, client review, form filling, etc. With the compliance scenario prediction model, the total TTlive full-service can be reduced from 5 hrs to 2.5 hrs.

Embodiments of the present disclosure provide a practical computer-centric solution by integrating completeness graph data structure with machine learning technology to generate a fast speed compliance scenario prediction model to process user profiles to accurately and efficiently implement rule-based qualification determination for a topic. The practical solution reduces time involved in the data entry process by predicting the most likely user scenario and presenting the most important and relevant questions to the user upfront.

Embodiments of the present disclosure provide several improvements and advantages for online form processing services, including:
1) within a topic, reducing average topic execution and determination time by predicting a user completeness scenario (path) to infer personalized responses to the most relevant decision questions;
2) reducing customer service time per task implementation by only asking data entry questions and presenting inferred and personalized responses to certain decision questions;
3) reducing the overall number of questions asked to the user, thereby optimizing the execution of the static predefined rules in a completeness graph for a topic;
4) providing more than 90% scenario prediction accuracy;
5) reducing the computing system memory and resources to complete the service tasks;
6) simplifying completeness graph data structure and predicting compliance scenarios representing completeness paths for scenario cohorts;
7) inferring responses in the completeness graph and dynamically ordering the list of questions to ensure only the most relevant questions are generated and presented to the user;
8) detecting the need to automatically create hierarchical models by lining different scenario prediction models based on the relationships of different topics;
9) enhancing and improving customers' satisfaction by automatically inferring personalized responses of the most relevant questions for users to confirm and review; and
10) providing computational efficiency and predictive accuracy with related machine learning tasks.

Embodiments of the present disclosure may create an online form filing service product to process user data in real time, predict user cohort to infer personalized responses to certain questions for user to review and confirm quickly, and create personalized user experience to meet user needs during a topic completion process. The embodiments described herein improve user experience when the users interact with online services while improving accuracy, efficiency, and productivity of online form filing processes.

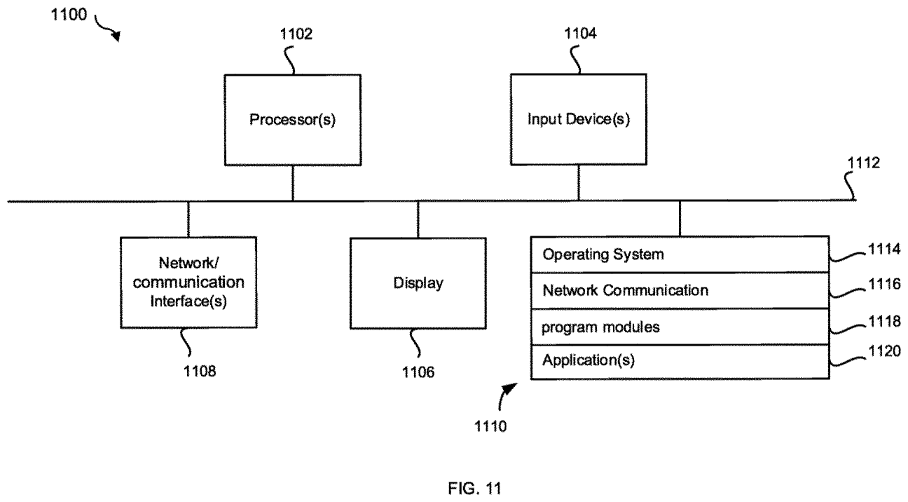

FIG. 11 is a block diagram of an example computing device 1100 that may be utilized to execute embodiments to implement processes including various features and functional operations as described herein. For example, computing device 1100 may function as server computing device 120, and user computing device 130 or a portion or combination thereof. In some implementations, the computing device 1100 may include one or more processors 1102, one or more input devices 1104, one or more display devices or output devices 1106, one or more communication interfaces 1108, and memory 1110. Each of these components may be coupled by bus 1112, or in the case of distributed computer systems, one or more of these components may be located remotely and accessed via a network. The computing device 1100 may be implemented on any digital device to execute software applications derived from program instructions stored in the memory 1110, and includes but not limited to personal computers, servers, smartphones, media players, digital tablets, game consoles, email devices, etc.

Processor(s) 1102 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-transitory memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Input devices 1104 may be any known input devices technology, including but not limited to a keyboard (including a virtual keyboard), mouse, track ball, and touch-sensitive pad or display. To provide for interaction with a user, the features and functional operations described in the disclosed embodiments may be implemented on a computer having a display device 1106 such as a CRT (cathode ray tube) or LCD (liquid crystal display) monitor for displaying information to the user and a keyboard and a pointing device such as a mouse or a trackball by which the user can provide input to the computer. Display device 1106 may be any known display technology, including but not limited to display devices using Liquid Crystal Display (LCD) or Light Emitting Diode (LED) technology.

Communication interfaces 1108 may be configured to enable computing device 1100 to communicate with other another computing or network device across a network, such as via a wired connection, a wireless connection, or a combination of wired and wireless connections. For example, communication interfaces 1108 may include an Ethernet interface, an optical interface, a coaxial interface, an infrared interface, a radio frequency (RF) interface, a universal serial bus (USB) interface, a Wi-Fi interface, a cellular network interface, or the like.

Memory 1110 may be any computer-readable medium that participates in providing computer program instructions and data to processor(s) 1102 for execution, including without limitation, non-transitory computer-readable storage media (e.g., optical disks, magnetic disks, flash drives, etc.), or volatile media (e.g., SCRAM, ROM, etc.). Memory 1110 may include various instructions for implementing an operating system 814 (e.g., Mac OS®, Windows®, Linux). The operating system may be multi-user, multiprocessing, multitasking, multithreading, real-time, and the like. The operating system may perform basic tasks, including but not limited to: recognizing inputs from input devices 1104; sending output to display device 1106; keeping track of files and directories on memory 1110; controlling peripheral devices (e.g., disk drives, printers, etc.) which can be controlled directly or through an I/O controller; and managing traffic on bus 1112. Bus 1112 may be any known internal or external bus technology, including but not limited to ISA, EISA, PCI, PCI Express, USB, Serial ATA or FireWire.

Network communications instructions 1116 may establish and maintain network connections (e.g., software applications for implementing communication protocols, such as TCP/IP, HTTP, Ethernet, telephony, etc.). Application(s) 1120 and program modules 1118 may include software application(s) and different functional program modules which are executed by processor(s) 1102 to implement the processes described herein and/or other processes. For example, the program modules 1118 may include a completeness scenario prediction system 124. The program modules 1118 may include but are not limited to software programs, machine learning models, objects, components, data structures that are configured to perform tasks or implement the processes described herein. The processes described herein may also be implemented in operating system 1114.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system that includes a back-end component, such as a data server, or that includes a middleware component, such as a server computing device or an Internet server, or that includes a front-end component, such as a user device having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user computing devices and server computing devices. A user computing device and server may generally be remote from each other and may typically interact through a network. The relationship of user computing devices and server computing device may arise by virtue of computer programs running on the respective computers and having a client-server relationship to each other.

Communication between various network and computing devices 1100 of a computing system may be facilitated by one or more application programming interfaces (APIs). APIs of system may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. One or more features and functional operations described in the disclosed embodiments may be implemented using an API. An API may define one or more parameters that are passed between an application and other software instructions/code (e.g., an operating system, library routine, function) that provides a service, that provides data, or that performs an operation or a computation. A parameter may be a constant, a key, a data structure, an object, an object class, a variable, a data type, a pointer, an array, a list, or another call.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method implemented by a server computing device, the server computing device comprising a processor and a memory storing computer-executable computer instructions, the method comprising executing the instructions by the processor to cause the server computing device to perform processing comprising:
receiving, from a database in communication with the processor, user feature datasets associated with a plurality of users and a topic;
obtaining a completeness graph data structure associated with the topic from the memory, the completeness data structure being represented by a completeness graph established based on logical dependencies of compliance rules for the topic, the completeness graph comprising a plurality of nodes comprising one or more decision nodes interconnected by edges, each decision node corresponding to a question with a functional condition to determine respective decision values, the edges representing the decision values and the logical dependencies between different nodes;
identifying a set of completeness paths for completing the topic from the completeness graph to generate a set of query datasets comprising cohort labels, each query dataset comprising a cohort label, a set of decision nodes, respective questions and decision values along each completeness path;
generating a compliance scenario prediction model that predicts a set of scenario cohorts that constitute a set of compliance scenarios, each compliance scenario representing a completeness path for the respective scenario cohort;
executing the compliance scenario prediction model to process a new user profile including new data features associated with the topic and a user to predict a scenario cohort and a compliance scenario corresponding to the predicted cohort for the user; and
automatically inferring one or more personalized responses to a question of the respective decision node in the predicted compliance scenario for the user.

2. The method of claim 1, wherein identifying the set of completeness paths from the completeness graph comprises:
parsing and filtering the decision nodes and decision values of the completeness graph based on the dependent logic between the decision nodes through the edges in the completeness graph; and
processing the query datasets to query the user feature datasets to determine the cohort labels for the user feature datasets.

3. The method of claim 1, further comprising mapping the predicted scenario cohort to the compliance scenario for the user to identify the decision value to the respective decision node in the compliance scenario.

4. The method of claim 1, further comprising:
generating a personalized user interface to present the inferred responses with the respective question to a device associated with the user; and
in response to receiving at least one user confirmation to the inferred responses, calculating the decision value to the respective question, presenting relevant non-decision questions and determining whether the user profile satisfies requirements in the completeness graph for a topic determination.

5. The method of claim 1, wherein generating the compliance scenario prediction model further comprises:
determining a cohort distribution of the user feature datasets corresponding to the set of the scenario cohorts;
determining a first set of top-ranked scenario cohorts that cover at least a range of 90% of the plurality of users; and
training the scenario prediction model with the user feature datasets associated with the first set of the top-ranked scenario cohorts and respective cohort labels.

6. The method of claim 5, further comprises determining respective accuracy measures for the first set of the top-ranked scenario cohorts during training the machine learning model.

7. The method of claim 6, further comprising:
determining whether an accuracy measure for the predicted cohort for the user is lower than a threshold value;
in response to determining that the accuracy measure for the predicted cohort for the user is lower than the threshold value, executing the compliance scenario prediction model to process the user feature dataset to predict a second set of top-ranked scenario cohorts and corresponding compliance scenarios for the user;
automatically identifying most relevant questions of the decision nodes in respective compliance scenarios associated with the second set of the top-ranked scenario cohorts;
inferring personalized responses to the most relevant questions;
generating a personalize user interface to present the personalized responses to the most relevant questions to the device associated with the user; and
in response to receiving a user confirmation of the personalized responses to the most relevant questions, determining a correct cohort from the second set of the top-ranked cohorts for the user and whether the user profile satisfies the completeness graph.

8. The method of claim 7, wherein automatically identifying the most relevant questions of the decision nodes further comprises dynamically reordering the most relevant personalized questions thereby modifying a sequence of the questions corresponding to the decision nodes and non-decision nodes along the completeness path.

9. The method of claim 7, wherein a number of the second set of the top-ranked scenario cohorts is dynamically adjusted to maximize a total accuracy measure of the second set of the predicted cohorts to be above the threshold.

10. The method of claim 7, wherein the second set of top-ranked scenario cohorts are predicted based on the first set of the scenario cohorts.

11. A computing system, comprising:
a server computing device comprising a processor and a memory;
a database in communication with the processor and configured to store a plurality of completeness graphs and user feature datasets, and
a scenario prediction system comprising a plurality of scenario prediction models, the scenario prediction system including computer-executable instructions stored in a memory and executed by the processor to cause the server computing device to perform processing comprising:
receiving, from the database in communication with the processor, the user feature datasets associated with a plurality of users and a topic;
obtaining a completeness graph data structure associated with the topic from the memory, the completeness data structure being represented by a completeness graph established based on logical dependencies of compliance rules for the topic, the completeness graph comprising a plurality of nodes comprising one or more decision nodes interconnected by edges, each decision node corresponding to a question with a functional condition to determine respective decision values, the edges representing the decision values and the logical dependencies between different nodes;
identifying a set of completeness paths for completing the topic from the completeness graph to generate a set of query datasets comprising cohort labels, each query dataset comprising a cohort label, a set of decision nodes, respective questions and decision values along each completeness path;
generating a compliance scenario prediction model that predicts a set of scenario cohorts that constitute a set of compliance scenarios, each compliance scenario representing a completeness path for the respective scenario cohort;
executing the compliance scenario prediction model to process a new user profile including new data features associated with the topic and a user to predict a scenario cohort and a compliance scenario corresponding to the predicted cohort for the user; and
automatically inferring one or more personalized responses to a question of the respective decision node in the predicted compliance scenario for the user.

12. The system of claim 11, wherein identifying the set of completeness paths from the completeness graph comprises:
parsing and filtering the decision nodes and decision values of the completeness graph based on the dependent logic between the decision nodes through the edges in the completeness graph; and
processing the query datasets to query the user feature datasets to determine the cohort labels for the user feature datasets.

13. The system of claim 11, further comprising mapping the predicted scenario cohort to the compliance scenario for the user to identify the decision value to the respective decision node in the compliance scenario.

14. The system of claim 11, further comprising:
generating a personalized user interface to present the inferred responses with the respective question to a device associated with the user; and
in response to receiving at least one user confirmation to the inferred responses, calculating the decision value to the respective question, presenting relevant non-decision questions and determining whether the user profile satisfies requirements in the completeness graph.

15. The system of claim 11, wherein generating the compliance scenario prediction model further comprises:
determining a cohort distribution of the user feature datasets corresponding to the set of the scenario cohorts;
determining a first set of top-ranked scenario cohorts that cover at least a range of 90% of the plurality of users; and
training the scenario prediction model with the user feature datasets associated with the first set of the top-ranked scenario cohorts and respective cohort labels.

16. The system of claim 15, further comprising determining respective accuracy measures for the first set of the top-ranked the scenario cohorts during training the machine learning model.

17. The system of claim 16, further comprising:
determining whether an accuracy measure for the predicted cohort for the user is lower than a threshold value;
in response to determining that the accuracy measure for the predicted cohort for the user is lower than the threshold value, executing the compliance scenario prediction model to process the user feature dataset to predict a second set of top-ranked scenario cohorts and corresponding compliance scenarios for the user;
automatically identifying most relevant questions of the decision nodes in respective compliance scenarios associated with the second set of the top-ranked scenario cohorts;
inferring personalized responses to the most relevant questions;
generating a personalize user interface to present the personalized responses to the most relevant questions to the device associated with the user; and
in response to receiving a user confirmation of the personalized responses to the most relevant questions, determining the correct cohort from the second set of the top-ranked cohorts for the user and whether the user profile satisfies the completeness graph for a topic determination.

18. The system of claim 17, wherein automatically identifying the most relevant questions of the decision nodes further comprises dynamically reordering the most relevant personalized questions thereby modifying a sequence of the questions corresponding to the decision nodes and non-decision nodes along the completeness path.

19. The system of claim 17, wherein a number of the second set of the top-ranked scenario cohorts is dynamically adjusted to maximize a total accuracy measure of the second set of the predicted cohorts to be above the threshold.

20. The system of claim 17, wherein the second set of top-ranked scenario cohorts are predicted based on the first set of the scenario cohorts.
